(19) United States
(12) Patent Application Publication
(10) Pub. No.: US 2005/0092815 A1
(43) Pub. Date: May 5, 2005

(54) Semiconductor device and wire bonding method

(75) Inventor: Tatsunari Mii, Tachikawa (JP)

Correspondence Address: KODA & ANDROLIA, 2029 CENTURY PARK EAST, SUITE 1140, LOS ANGELES, CA, 90067-2912, US

(73) Assignee: Kabushiki Kaisha Shinkawa

(21) Appl. No.: 10/978,553

(22) Filed: Nov. 1, 2004

(30) Foreign Application Priority Data
Oct. 30, 2003 (JP) 2003-370323
Mar. 23, 2004 (JP) 2004-084048

(51) Int. Cl. B23K 31/02

(52) U.S. Cl. 228/180.5

(57) ABSTRACT

A wire bonding method that performs a primary bonding of wire on a first bonding point and performs a secondary bonding of the wire on a second bonding point, thus connecting the first and second bonding points with the wire, the secondary bonding including: a first bonding step that forms a first bonding part by bonding the wire to the second bonding point, a second bonding step that forms a second bonding part by raising a capillary through which the wire passes and moving the capillary toward the first bonding point, and then lowering the capillary and overlapping the wire to connect the wire to the first bonding part, and a ting step that cuts the wire.

### BACKGROUND OF THE INVENTION

1. Technical Field

The present invention relates to a semiconductor device and wire bonding method in which a pad on a die and wiring of a circuit board are connected by a wire.

2. Description of the Related Art

A die on which pads are formed is mounted on a circuit board on which wiring is formed. The connection of a wire between such pads and wiring is, in order to prevent damages to the pad, generally accomplished by performing ball bonding (a primary bonding) on the pad of a die, looping the wire, and then performing wedge bonding (a secondary bonding) on the wiring. However, in ball bonding, a rise occurs in the wire; as a result, the looped wire tends to be high when the primary bonding is performed on the pad of the die.

Accordingly, in one method, primary bonding is performed on the wiring, and secondary bonding is performed on the pad of the die, thus being a reverse of that described above. However, in wedge bonding that constitutes secondary bonding, the wire itself is bonded, and the wire is cut; accordingly, the undersurface of the capillary through which the wire passes contacts the pad, so that cracks, etc., are generated in the die.

In order to prevent the above problem, Japanese Patent Application Laid-Open (Kokai) No. H5-326601 discloses a method in which ball bonding is performed beforehand on the pad so as to form a bump, primary bonding is subsequently performed on the wiring, and secondary bonding is then performed on the bump located on the pad after the wire is looped.

However, in the method of this prior art, since it is necessary to form bumps beforehand, the number of steps required increases, and thus a problem of cost increase arises.

### BRIEF SUMMARY OF THE INVENTION

The object of the present invention is to provide a semiconductor device and a wire bonding method that would not damage pads even if secondary bonding is performed on the pads without forming bumps beforehand on the pads.

The above object is accomplished by a unique structure of the present invention for a semiconductor device in which a ball formed on the tip end of a wire is connected to a first bonding point, and the wire is then connected to a second bonding point, so that the first bonding point and the second bonding point are connected by the wire; and in the present invention, the second bonding point is comprised of:
a first bonding part formed by the wire connected to the second bonding point, and
a second bonding part formed by the wire that is overlapped on and connected to the first bonding part.

The above object is further accomplished by unique steps of the present invention for a wire bonding method that performs a primary bonding of wire on a first bonding point and performs a secondary bonding of the wire on a second bonding point, thus connecting the first bonding point and the second bonding point with the wire; and in the present invention, the secondary bonding comprises:
a first bonding step that forms a first bonding part by bonding the wire to the second bonding point,
a second bonding step that forms a second bonding part by raising a capillary through which the wire passes and moving the capillary toward the first bonding point, and then lowering the capillary, thus allowing the wire to be overlapped on and connected to the first bonding part, and
a cutting step that cuts the wire.

In the above method, the first bonding part is formed by lowering the capillary such that the undersurface of the capillary does not come. into contact with the upper surface of the second bonding point and wire is not cut through.

In the present invention, the first bonding point can be wiring on a circuit board, and the second bonding point can be a pad on a die.

As seen from the above, in the present invention, the secondary bonding is performed by a process that forms a first bonding part by connecting the wire to the pad in a first bonding operation, forms a second bonding part by overlapping the wire on the first bonding part in a second bonding operation, forms a cutting thin part, and then cut the wire. Accordingly, even if the secondary bonding is performed on a pad without forming a bump on the pad beforehand, the capillary does not come into contact with the pad, and no damage occurs to the pad.

### BRIEF DESCRIPTION OF THE SEVERAL VIEWS OF THE DRAWINGS

FIGS. 1(a) through 1(f) show steps of one embodiment of the wire bonding method of the present invention; and

FIGS. 2(a) and 2(b) show the steps that follow the step of FIG. 1(f).

### DETAILED DESCRIPTION OF THE INVENTION

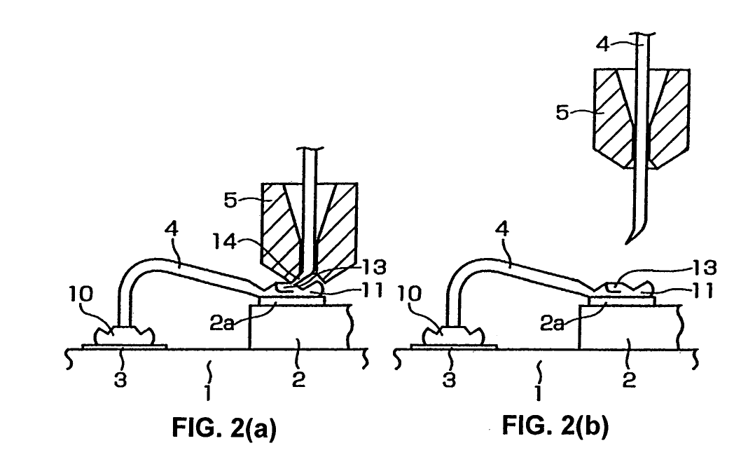

One embodiment of the semiconductor device of the present invention will be described with reference to FIG. 2(b) that shows a completed semiconductor.

A die 2 on which a pad 2a is formed is mounted on a circuit board 1, which is a ceramic board, a printed board, a lead frame, etc. Wiring 3 is formed on the circuit board 1.

In this semiconductor device, a ball formed on the tip end of a wire 4 is connected to the wiring 3 that is the first bonding point, thus forming a crimped ball 10; and the wire 4 is connected to a pad 2a which is on the die 2, the pad 2a being the second bonding point, so that the wiring 3 and pad 2a are connected by the wire 4. The connected shape of the wire on the pad 2a that constitutes the second bonding point is comprised of a first bonding part 11 formed by the connection of the wire 4 to the pad 2a and a second bonding part 13 formed by overlapping and connecting the wire 4 to this first bonding part 11.

Thus, the connection of the wire 4 to the pad 2a has a shape in which the first bonding part 11 is formed by connecting the wire 4 to the pad 2a in the first bonding operation and a second bonding part 13 is formed by overlapping the wire 4 on this first bonding part 11. Accordingly, there is no damage to the pad 2a even if bumps are not formed on the pad 2a beforehand.

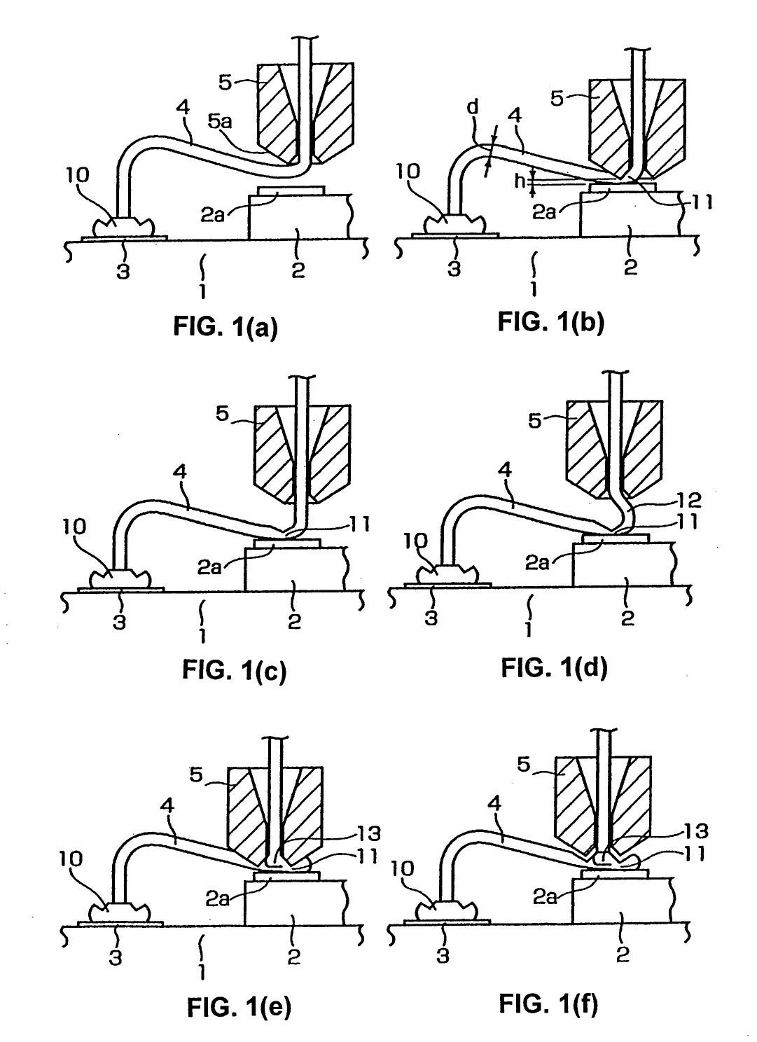

Next, one embodiment of the wire bonding method of the present invention that is used to obtain a semiconductor device such as that shown in FIG. 2(b) will be described with reference to FIGS. 1 and 2.

First, as shown in FIG. 1(a), with a damper (not shown) that clamps the wire 4 being open, the capillary 5 is lowered and a ball formed on the tip end of the wire 4 is bonded to the wiring 3 so that a crimped ball 10 is formed.

Subsequently, the capillary 5 is raised and moved toward the pad 2a, the wire 4 is paid out of the capillary 5, and the undersurface 5a of the capillary 5, which is on the wiring 3 side, is positioned above the pad 2a.

Next, as shown in FIG. 1(b), the capillary 5 is lowered and the wire 4 is bonded to the pad 2a, so that a first bonding part 11 is formed. In this case, the wire 4 is not completely crushed and bonded by the capillary 5 (as in a conventional method); instead, the first bonding part 11 is formed by lowering the capillary 5 so that the undersurface of the capillary 5 does not come into contact with the upper surface of the pad 2a and the wire 4 is prevented from being cut through. For example, the wire 4 is crushed by the capillary 5 by ½ to ⅔ of the diameter of the wire 4. More specifically, the first bonding part 11 is formed by lowering the undersurface of the capillary 5 to a position that is located above the upper surface of the pad 2a by a height of h (h=(⅓ to ½)d).

Next, as shown in FIG. 1(c), the capillary 5 is raised.

Then, as shown in FIG. 1(d), the capillary 5 is moved toward the wiring 3 or toward the first boding point.

As shown in FIG. 1(e), the capillary 5 is then lowered, thus bending a part 12 of the wire which is between the capillary and the first bonding part 11 as shown in FIG. 1(d), bonding the wire part 12 onto the first bonding part 11, and forming the second bonding part 13.

Next, as shown in FIG. 1(f), the capillary 5 is raised slightly.

Then, as shown in FIG. 2(a), the capillary 5 is moved slightly in the opposite direction from the wiring 3, thus forming a cutting thin part 14 in the wire 4.

Next, as shown in FIG. 2(b), a damper (not shown) and the capillary 5 are both raised, and the damper is closed at an intermediate point during this raising movement, so that the wire 4 is cut at the cutting thin part 14. Alternatively, it can be done following the step of FIG. 1(e) that the damper and capillary 5 are both raised and thus the wire 4 is cut by closing the clamper at an intermediate point during this raising movement. As a result, the wire 4 is electrically connected between the wiring 3 and pad 2a.

As seen from the above, the secondary bonding (done on a pad) is performed by a process that first forms a first bonding part 11 by connecting the wire 4 to the pad 2a in a first bonding operation, next forms a second bonding part 13 by overlapping the wire 4 on the first bonding part 11 in a second bonding operation, and then forms the cutting thin part 14, and finally cuts the wire 4. Accordingly, no damage occurs to the pad(s) 2a even if the secondary bonding is performed on the pad(s) 2a without forming bumps on the pad(s) 2a beforehand.

1. A semiconductor device in which a ball formed on a tip end of a wire is connected to a first bonding point, and said wire is then connected to a second bonding point, so that said first bonding point and said second bonding point are connected by said wire, wherein said second bonding point is comprised of:
a first bonding part which is formed by said wire connected to said second bonding point, and
a second bonding part which is formed by said wire overlapped on and connected to said first bonding part.

2. The semiconductor device according to claim 1, wherein said first bonding point is wiring on a circuit board, and said second bonding point is a pad on a die.

3. A wire bonding method that performs a primary bonding of wire on a first bonding point and performs a secondary bonding of said wire on a second bonding point, thus connecting said first bonding point and said second bonding point with said wire, wherein said secondary bonding comprises:
a first bonding step that forms a first bonding part by bonding said wire to said second bonding point,
a second bonding step that forms a second bonding part by raising a capillary through which said wire passes and moving said capillary toward said first bonding point, and then lowering said capillary, thus allowing said wire to be overlapped on and connected to said first bonding part, and
a cutting step that cuts said wire.

4. The wire bonding method according to claim 3, wherein said first bonding part is formed by lowering said capillary such that an undersurface of said capillary is prevented from making contact with an upper surface of said second bonding point and said wire is prevented from being cut.

5. The wire bonding method according to claim 4, wherein said first bonding point is wiring on a circuit board, and said second bonding point is a pad on a die.
